(19) United States
(12) Patent Application Publication
(10) Pub. No.: US 2006/0230901 A1
(43) Pub. Date: Oct. 19, 2006

(54) Attachment for a saw

(76) Inventor: Adam J. Figurski, Murrieta, CA (US)

Correspondence Address: CALIF KIP TERVO;MARY JO REDMAN, LAW OFFICES OF CALIF KIP TERVO, 6387 CAMINITO LAZARO, SAN DIEGO, CA, 92111, US

(21) Appl. No.: 11/105,112

(22) Filed: Apr. 13, 2005

(51) Int. Cl. B26D 7/02

(52) U.S. Cl. 83/465; 83/471.3

(57) ABSTRACT

Attachment for a saw simplifies cutting of crown molding by supporting molding at “spring” angle during cutting. Attachment includes clamp for removably mounting attachment on saw fence, and a right triangle having a hypotenuse congruent with “spring” angle. Attachment makes possible cutting of compound angle using only miter adjustment of saw.

### FIELD OF THE INVENTION

This invention relates in general to attachments for saws and more specifically to workpiece supporting attachments for circular saws.

### BACKGROUND OF THE INVENTION

Crown molding is an ornamental strip of wood or plastic that is used to cover a seam or joining in a building, such as the joining of a wall and ceiling.

A widely used style of crown molding is known as “52/38” molding. Such molding has an ornamental face, typically with linear design motifs, which faces down into the room, and a plain face that faces the dihedral corner. The plain face includes a flat back and two beveled ends that fit generally flush against the wall and ceiling such that the flat back is disposed at an angle of 38° to the vertical wall and 52° to the horizontal ceiling. This is known as a “spring angle” of 52/38.

Pieces of crown molding are typically cut to size with a “chop” or “end cut” saw. Chop saws have a circular blade in a housing that is pivotably mounted upon a horizontal base. The base typically includes an adjustable elongate fence that extends parallel to the axis of rotation of the saw blade. The fence supports a workpiece to be cut such that the workpiece is held perpendicular to the axis of rotation of the blade. Frequently, the fence includes two pieces, one on either side of the blade. Fences may be fixed in place, or the position on the table may be adjustable. To make a cut, the housing is first pivoted upward to allow the workpiece to be put into position on the base against the fence. Then the housing is pivoted downward to bring the blade against the workpiece and cut it.

The blade is nominally mounted such that the blade is vertical and perpendicular to the fence. In this configuration, the cut made will create a surface that is normal to the length of the crown molding. In order to fit the crown molding snugly around corners and architectural features, it is often necessary to make cuts that are not normal to the length of the molding.

A chop saw blade typically has two degrees of freedom available for angling the direction of cut: the blade may be angled away from vertical (bevel) or away from perpendicular to the length of the fence (miter). If the blade is angled in both degrees of freedom, the cut is called a “compound angle.”

Crown molding has the reputation of being very difficult to cut and install, largely due to the need for compound angles. Compound angles are typically set on a saw relative to the nominal configuration of the saw blade normal to the fence and horizontal base. In the case of crown molding, though, the spring angle affects the set up of the cutting angle. Conventionally, this is compensated for by using reference charts available in woodworking books or on the Web. The desired bevel and miter cut angles are looked up on a table or spreadsheet for crown molding of a given spring angle, which lists the saw settings that are needed to produce the desired cut on a piece of crown molding that is disposed horizontally on the saw table. Alternatively, the saw angles can be calculated individually on paper or with a calculator.

To further complicate the job, the crown molding is conventionally oriented on the saw base and against the fence with the ornamental face downward. Even carpenters with experience with crown molding sometimes become confused over which side of a cut is the piece to be installed and set up a cut with all or some of the angles complementary to the angles actually needed. Inexperienced persons frequently make many incorrect cuts before realizing the problem. Wrong cuts are frustrating, waste time, and ruin expensive molding.

Crown molding would be far simpler to cut if the molding were disposed at the spring angle during cutting. Also, fewer mistakes would be made if the crown molding were oriented on the saw base with the ornamental face upward, that is, in the same orientation in which it will be installed.

Specialized saws, jigs, and fences have been designed to simplify cutting crown molding. A finish carpenter who does only crown molding installation might wish to invest in a special saw, or choose to modify his or her saw by attaching a special jig or fence. However, such specialized equipment is not widely available and is not practical for those who do not install crown molding routinely. The jigs or fences for cutting crown molding that are currently known require modification of the saw base, such as the drilling of mounting holes. In addition to the damage to the saw, installation and removal of a special jig or fence is time-consuming and may require some special knowledge or expertise on the part of the carpenter.

Therefore, there is a need for a crown molding attachment for a chop saw that is inexpensive, easily and quickly installed and removed without damage or modification to the saw, and that does not require any special knowledge of geometry or mechanics from the user. There is a need for a crown molding attachment that simplifies compound angle cutting so that reference tables or mathematical calculations are not needed to set up the saw. There is a further need for such an attachment for a saw that allows crown molding to be cut while in the orientation in which it will be installed, so that the carpenter is unlikely to become confused about which end of the cut is to be kept.

### SUMMARY OF THE INVENTION

This invention is an attachment for a chop saw that simplifies cutting compound angles on crown molding. The attachment includes a support area that supports the crown molding above the saw base at an angle replicating the spring angle of the molding. Because the molding is supported at the spring angle during the cutting, the spring angle does not need to be included in set up of the cutting angle. Therefore, the saw is set up as if for a simple miter cut, without reference to angle tables.

The attachment of the present invention includes mounting means for mounting the attachment upon the saw base or fence; and supporting means attached to the mounting means for supporting the length of molding to be cut. The supporting means includes a support area defining a support plane. Angle means attached between mounting means and supporting means disposes the support plane at a predetermined angle, typically the spring angle of the crown molding.

The mounting means is typically a spring or screw clamp that allows the attachment to be removably mounted on the saw fence without modification or damage to the fence or saw. The angle means and supporting means are typically combined as a right triangle of rigid sheet material attached to the clamp. The hypotenuse of the triangle replicates the spring angle of the crown molding. For example, in the case of an attachment for use with 52/38 molding, the lower vertex of the triangle is 38°, the upper rear vertex is 90°, and the remaining vertex is 52°.

The support area is disposed along the hypotenuse of the triangle. When the attachment is mounted upon the saw fence, the support area defines a plane that is angled 52° relative to the plane of the saw base and 38° relative to vertical. The support area is for supporting the non-ornamental face of a length of crown molding at its spring angle such that it is available to be cut by the saw.

Preferably, a pair of attachments is mounted upon a saw fence. The two attachments are spaced apart on the fence, typically with one attachment mounted on each side of the saw blade0. A length of crown molding is supported by the two attachments. The crown molding is maintained in position against the support area, typically by lightly pressing with a thumb. Because the crown molding is supported by the attachment in the same orientation in which the molding will be attached to the corner of wall and ceiling, the kept piece and discard piece are clearly distinguished.

Attachments of the present invention can be used with most types and makes of chop saw. Because of differences among designs of saw, attachments of different dimensions may be needed. Generally, it has been found that the attachment of the present invention can be used with all generally available chop saws if manufactured in two sizes. A pair of same-sized attachments is recommended for most saws; some saws require one attachment of each size to be used.

The present invention is an inexpensive, foolproof attachment for simplifying the cutting of the ends of crown molding. A pair of attachments is light and takes up little space in a toolbox. The attachments can be mounted upon a saw in seconds and without measuring or adjusting the support angle. The attachments do not damage the saw and do not require that any holes be drilled in the base or fence; no adhesive or tools are required. Because the crown molding is supported at the spring angle during cutting, a calculator or a reference table is not needed. Use of the attachment usually allows the crown molding to be cut with only a miter angle adjustment of the saw blade, which speeds set up of the saw and decreases the chance of mistake. Because the crown molding is supported in the same orientation as when it is installed, no backward cuts are made and material is not wasted.

The features and advantages of the invention will be readily understood when the detailed description thereof is read in conjunction with the drawings wherein like reference numerals refer to like parts throughout.

### BRIEF DESCRIPTION OF THE DRAWINGS

FIG. 1 is a perspective view of a preferred embodiment of a single attachment.

FIG. 2 is a perspective view of an exemplary chop saw with two of the attachments of FIG. 1 mounted.

FIG. 3 is a side view, partly cut away, of the saw of FIG. 2 with mounted attachment supporting a length of crown molding.

### DETAILED DESCRIPTION OF THE INVENTION

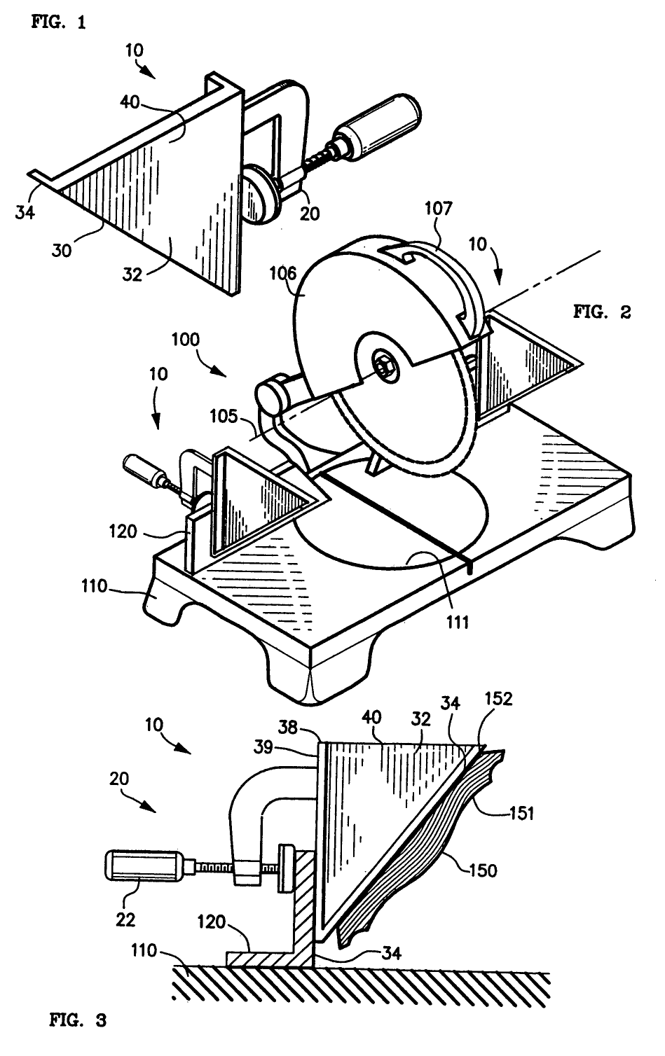

FIG. 1 is a perspective view of a preferred embodiment of a single attachment 10 of the present invention. Attachment 10 generally includes mounting means 20 for mounting attachment 10 on a saw and supporting means 30 for supporting a piece of crown molding during cutting. Supporting means 30 includes a support area 34 defining a support plane. Angle means 40 attached between mounting means 20 and support area 34 disposes support angle at a predetermined dihedral angle relative to the fence, typically the spring angle of the crown molding.

Angle means 40 in the preferred embodiment 10 illustrated is a right triangle 32 having a hypotenuse that is angled, relative to the vertical fence, at the spring angle of the crown molding. Support area 34 is a widened area, such as a flange, connected along the hypotenuse of triangle 32.

FIG. 2 is a perspective view of an exemplary chop saw 100 with a pair of attachments 10, each attachment 10 mounted upon a fence 120. Chop saw 100 includes a circular blade 101 that rotates about an axis of rotation 105. Blade 101 is mounted in housing 106, which is pivotably attached to base 110. Blade 101 can be pivoted between an “idle” position and a “cut” position (shown) in which blade 101 is between the two exemplary fences 120, and the outer cutting edge of blade 101 is adjacent the cutting table 111 of base 110. Handle 107 is gripped in order to move blade 101 between positions.

In addition to the pivoting movement between “idle” and “cut” positions, blade 101 has two degrees of freedom for adjusting the cut angle. In the nominal, or “zero-zero” adjustment, blade 101 is perpendicular to the surface of cutting table 111. Axis of rotation 105 is parallel to cutting table 111 and the lengths of fences 120. Blade 101 is also perpendicular to fences 120, which extend vertically upward from, and perpendicular to, cutting table 111. In the nominal adjustment, saw 100 would cut a workpiece that was supported against fences 120 with a straight 90° cut.

Blade 101 may be angled away from vertical (bevel) or away from perpendicular to the length of fences 120 (miter). If blade 101 is angled in both degrees of freedom, the cut is called a “compound angle.” If crown molding 150 is supported by table 111 and fence 120 while cutting with saw 100 at a bevel or compound angle, as according to the conventional method, the cut will be incorrect unless the spring angle is included in the set-up of the cut angle of blade 101. The proper bevel angle is typically determined by referring to a chart, which may be printed or posted on the Web.

FIG. 3 is a side view, partially cut away, of saw 100 of FIG. 2 with mounted attachment 10 supporting a length of crown molding 150.

Mounting means 20 is any means that is suitable for removably mounting attachment 10 on fence 120 without damaging any part of saw 100, requiring its modification, or interfering with the function of saw 100. Shown is a typical screw clamp 22 that cooperates with vertical rear 38 of triangle 32 to retain attachment 10 securely against fence 120. Other suitable mounting means 20, such as a spring clamp or a magnet attached to rear 38, may be used instead of screw clamp 22.

Supporting means 30 is for supporting a workpiece, such as crown molding 150, while it is sawn. Supporting means 30 consists of support area 34 in the preferred embodiment shown in the drawings. Support area 34 contacts the plain face 152 of crown molding 150 and steadies crown molding 150 during sawing. Support area 34 generally defines a support plane.

Angle means 40 is for disposing support area 34 at a predetermined angle, such as the spring angle of crown molding 150, such as 38° outward from vertical fence 120 in the embodiment illustrated in the figures. In the preferred embodiment of attachment 10 that is described and illustrated herein, angle means 40 is a right triangle 32, preferably made from a sheet of rather rigid material, such as polyethylene at least 0.1 inch thick. Triangle 32 has three vertices: a 90° angle shown in FIG. 3 in the upper left corner of triangle 32, a 52° angle in the upper right, and a 38° angle at the bottom. Triangle 32 is thus adapted for use with 52/38 style crown molding. Triangle 32 may be adapted for use with other styles of crown molding by varying the latter two angles.

Support area 34 is preferably a widened area, such as a flange, connected along the hypotenuse of triangle 32. Support area 34 is typically at least 0.5 inch wide. Support area 34 may be co-molded with triangle 32 or attached to triangle 32 by suitable means such as adhesive or welding. Alternatively, triangle 32 may itself be of sheet material about 0.5 inch thick, in which case, support area 34 would simply be the hypotenuse edge of triangle 32.

Alternatively, triangle 32 can be an outline of a triangle comprising three strips attached end-to-end. Alternatively, triangle 32 can be as minimal as a single V-shaped component, such as of molded ABS plastic, that includes rear 38 and support area 34.

Rear 38 of triangle 32 preferably includes a fence contact area 39 that is at least 0.5 inch wide. Contact area 39 can be a flange or widened area attached to the rear edge of triangle 32.

To use attachment 10, blade 101 of saw 100 should be in the set-up position to allow access to fence 120. Attachment 10 is mounted upon fence 120 by sliding attachment 10 over fence 120 such that screw clamp 22 is behind fence 120 and contact area 39 is in front of fence 120. Screw clamp 22 is tightened so that attachment 10 is secured to fence 120.

For greater stability, a pair of attachments 10 is used. Typically, one attachment 10 is mounted on each side of the location of blade 101 in the cut position.

Because chop saws vary, it has been found necessary to provide two sizes of attachment 10 to fit all saws. The smaller attachment 10 includes a rear 38 that is approximately 3 to 4.5 inches long. The larger attachment 10 includes a rear area 38 that is approximately 5.5 to 7 inches long. For a few saws, crown molding 150 is supported more stably if one attachment 10 of each size is used.

The cut angle of saw 100 is adjusted and the position on crown molding 150 where the cut should begin is marked. The length of crown molding 150 is moved toward support area 34 until plain face 152 contacts support area 34 and the cut mark is in the correct location. Typically, the user retains crown molding 150 in place against support area 34 with a hand, such as by resting the fingers on attachment 10 with the thumb pressing ornamental face 151. Alternatively, crown molding 150 may be retained in place by an auxiliary clip, as well known in the art.

Blade 101 is pivoted to the cut position by grasping handle 107 such that blade 101 contacts and passes through crown molding 150, cutting crown molding 150 at the desired angle. Blade 101 is pivoted back to the idle position. The properly cut portion of crown molding 150 is installed on the wall. The other, “discard” portion is either discarded as scrap or set aside for future use.

As mentioned above, triangle 32 can be a simple V-shape of material, consisting of rear 38 and support area 34. Such an embodiment of attachment 10 can be adapted to support crown molding 150 in either of two ways. Firstly, in the way described in detail above, wherein support area 34 is angled down toward cutting table 111 and crown molding 150 is retained against support area 34 by upward pressure by a thumb. Secondly, a V-shaped “triangle” 32 can be adapted so as to have support area 34 disposed on the inner face of the hypotenuse of triangle 32. To use this embodiment of attachment 10, crown molding 150 is placed on rearward- and upward-facing support area 34 with ornamental face 151 in contact with support area 34. This embodiment of attachment 10 just described disposes crown molding 150 at the spring angle during cutting in the orientation at which crown molding 150 will be installed, as do all the embodiments described herein; however this embodiment has the further benefit that support area 34 opposes the downward force of blade 101 and crown molding 150 does not need to be retained by a thumb. Other ways of providing a support area 34 capable of supporting crown molding at the spring angle during cutting will be obvious to one skilled in the art.

After use, attachment 10 is easily removed from fence 120 by loosening screw clamp 22. Saw 100 is undamaged and does not have screw holes or other modifications that may interfere with other uses.

It is seen from the above description that attachment 10 greatly simplifies the cutting of crown molding 150. Typically, the use of attachment 10 to dispose crown molding 150 at the spring angle during cutting makes it possible to cut a desired compound angle on crown molding 150 with only one (miter) adjustment of saw 100. Because the bevel angle does not need to be looked up on a table or calculated, set-up of saw 100 is quicker and fewer errors are made.

Attachment 10 also makes it possible to use a miter saw, without bevel angle adjustability, to cut compound angles in crown molding 150. In fact, saw 100 can even be a hand saw in combination with a simple miter box.

Although particular embodiments of the invention have been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. An attachment for a saw; the saw including: a generally horizontally planar base and a vertical blade; and capable of making miter cuts in a workpiece; said attachment for the purpose of simplifying the cutting of compound angles in a workpiece and including:
mounting means for mounting said attachment upon the saw; and
supporting means attached to said mount means for supporting the workpiece including:
a support area for contacting and supporting the workpiece; and
angle means attached to said support area for disposing said support area such that the workpiece is supported at a predetermined angle; and wherein: said attachment can be removably mounted upon the saw without damage to or modification of the saw.

2. The attachment of claim 1, wherein said support area generally defines a support plane; and wherein said mounting means is adapted such that the support plane is disposed at a predetermined dihedral angle relative to the saw base when said attachment is mounted upon the saw.

3. The attachment of claim 2, said angle means comprising:
a triangle having one angle corresponding to the predetermined angle for supporting the workpiece.

4. The attachment of claim 2, wherein said mounting means comprises:
a clamp for clamping said attachment to the saw; said clamp from the group of spring and screw clamps.

5. The attachment of claim 1, wherein the workpiece is a piece of crown molding; the crown molding including an ornamental face and a plain face opposite the ornamental face; and said support area is adapted to support the crown molding at the same angle and orientation at which the molding will be attached to a wall after cutting.

6. The attachment of claim 5, wherein the crown molding is supported with the plain face in contact with said support area.

7. The attachment of claim 1, wherein the saw includes a vertical circular blade rotating about a nominally horizontal axis; and a vertical fence attached to the saw base; and wherein said attachment is adapted for mounting upon the fence.

8. In combination:
a saw capable of making miter cuts; including:
a generally horizontally planar base; and
a vertical blade; and
an attachment mounted upon said saw for simplifying cutting of compound angles in a workpiece; including:
mounting means for mounting said attachment upon said saw; and
supporting means attached to said mounting means for supporting a workpiece; including:
a support area defining a plane; and
angle means attached to said support area for disposing said support area such that the workpiece is supported at a predetermined angle during cutting.

9. The combination of claim 8, said saw including:
a vertical circular blade rotating about a nominally horizontal axis; and
a vertical fence attached to the saw base; and wherein: said mounting means is adapted for removably mounting said attachment upon said fence without damage or modification to said saw.

10. The combination of claim 8; wherein the workpiece is a piece of crown molding; the crown molding including an ornamental face and a plain face opposite the ornamental face; and said support area is adapted to support the crown molding at the same angle and orientation at which the molding will be attached to a wall after cutting; such that a single miter cut of said saw creates a desired compound angle cut of the crown molding.

11. The combination of claim 10; said angle means comprising:
a right triangle having one angle corresponding to the angle at which the molding will be attached to a wall.
